(19) United States
(12) Patent Application Publication
(10) Pub. No.: US 2021/0312489 A1
(43) Pub. Date: Oct. 7, 2021

(54) OPERATION MANAGEMENT APPARATUS, OPERATION MANAGEMENT SYSTEM, OPERATION MANAGEMENT METHOD, AND VEHICLE

(71) Applicant: TOYOTA JIDOSHA KABUSHIKI KAISHA, Toyota-shi (JP)

(72) Inventors: Yuki TATSUMOTO, Nagoya-shi (JP); Saori MATSUMOTO, Chofu-shi (JP); Keigo YAMADA, Toyota-shi (JP); Akira SASAKI, Miyoshi-shi (JP); Mitsuhiro MIURA, Toyota-shi (JP)

(73) Assignee: TOYOTA JIDOSHA KABUSHIKI KAISHA, Toyota-shi (JP)

(21) Appl. No.: 17/200,004

(22) Filed: Mar. 12, 2021

(30) Foreign Application Priority Data
Apr. 3, 2020 (JP) 2020-067733

(51) Int. Cl. G06Q 30/02; G06Q 50/30

(52) U.S. Cl. CPC G06Q 30/0215; G06Q 50/30; G06Q 30/0283

(57) ABSTRACT

An operation management apparatus includes a controller configured to manage operation of a vehicle for boarding a user. The controller is configured to grant an incentive to the user based on an event that has occurred in the vehicle while the user is on board.

### CROSS-REFERENCE TO RELATED APPLICATION

This application claims priority to Japanese Patent Application No. 2020-067733 (filed on Apr. 3, 2020), the entire contents of which are incorporated herein by reference.

### TECHNICAL FIELD

The present disclosure relates to an operation management apparatus, an operation management system, an operation management method, and a vehicle.

### BACKGROUND

Vehicles which operate in accordance with demand from users are known. For example, Patent Literature (PTL) 1 discloses an operation management method for improving operation efficiency.

### CITATION LIST

### Patent Literature

PTL 1: JP 2019-016290 A

### SUMMARY

When the users are charged the same fare, some users who feel that their boarding conditions are poor may perceive a sense of unfairness with regards to fares against other users who appear to have good boarding conditions. Fare setting that brings a greater sense of fairness is desired.

It would be helpful to provide a sense of fairness to users.

An operation management apparatus according to an embodiment of the present disclosure includes

a controller configured to manage operation of a vehicle for boarding a user, wherein

the controller is configured to grant an incentive to the user based on an event that has occurred in the vehicle while the user is on board.

An operation management system according to an embodiment of the present disclosure includes:

the operation management apparatus; and

the vehicle.

An operation management method according to an embodiment of the present disclosure is executed by an operation management apparatus configured to manage operation of a vehicle for boarding a user. The operation management method includes granting an incentive to the user based on an event that has occurred in the vehicle while the user is on board.

A vehicle according to an embodiment of the present disclosure is a vehicle for boarding a user to operate. The vehicle is configured to transmit, to an operation management apparatus, information regarding an event that has occurred while operating with the user on board, so as to enable the operation management apparatus to grant the user an incentive based on the event.

According to the operation management apparatus, the operation management system, the operation management method, and the vehicle according to the embodiments of the present disclosure, a sense of fairness may be provided to users.

### BRIEF DESCRIPTION OF THE DRAWINGS

In the accompanying drawings:

FIG. 1 is a schematic diagram illustrating an example configuration of an operation management system according to an embodiment;

FIG. 2 is a block diagram illustrating an example configuration of the operation management system according to the embodiment; and

FIG. 3 is a flowchart illustrating an example of a procedure executed by a server.

### DETAILED DESCRIPTION

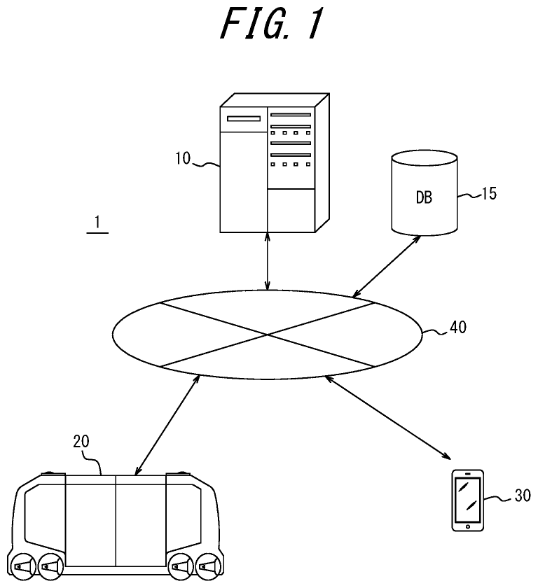

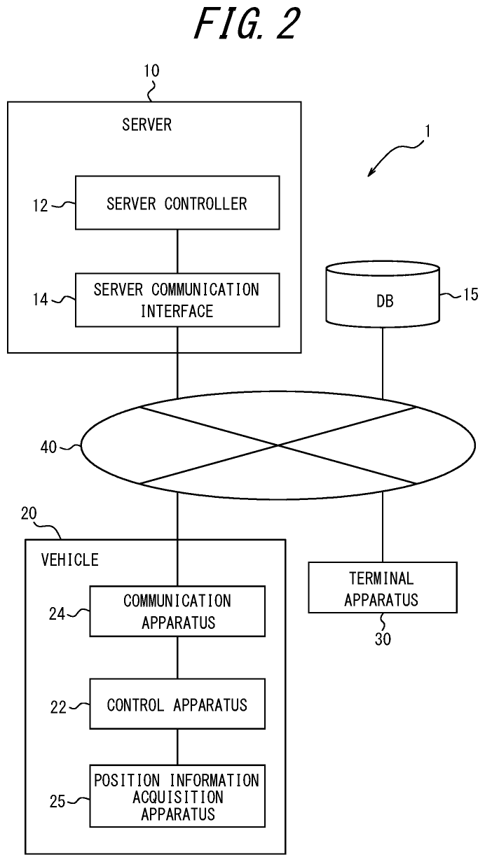

As illustrated in FIGS. 1 and 2, an operation management system 1 according to an embodiment includes a server 10, a vehicle 20, and a terminal apparatus 30. The operation management system 1 further includes a database (DB) 15, although this is not required. The server 10, the vehicle 20, the terminal apparatus 30, and the DB 15 are connected to a network 40 and are communicable with each other. Each of the server 10, the vehicle 20, the terminal apparatus 30, and the DB 15 is not limited to one and may be two or more in number.

The operation management system 1 provides an on-demand bus service for boarding a user to the vehicle 20 and travelling between at least two points so as to transport the user. The operation management system 1 manages the operation of the vehicle 20 so that the vehicle 20 can transport the user.

The user is in possession of the terminal apparatus 30 and may apply for use of the on-demand bus service provided by the vehicle 20 by accessing the server 10 through the terminal apparatus 30.

The server 10 may accept an application from the user for boarding and determine an operation route or an operation schedule for the vehicle 20 based on the application. The server 10 may determine whether the application from the user is acceptable based on an operation status of the vehicle 20. The server 10 may determine the operation route or the operation schedule for the vehicle 20 based on the status of the application from the user. The server 10 is also referred to as an operation management apparatus.

The operation management system 1 that manages the operation of the vehicle 20 may be operated by an entity providing the on-demand bus service, or by another different entity.

The server 10 may include a single server apparatus, or a plurality of server apparatuses capable of communicating with each other. The server 10 manages the application accepted from the user. The server 10 may transmit and receive various types of information regarding the provision of the on-demand bus service to and from the vehicle 20. The server 10 may be configured to execute, in addition to the above processing, various types of processing regarding the provision of the on-demand bus service. The server 10 manages the operation of the vehicle 20. The server 10 may communicate with the vehicle 20 to thereby acquire various types of information regarding the vehicle 20, such as a position or a speed of the vehicle 20. The server 10 may be configured to execute, in addition to the above processing, various types of processing to manage the operation of the vehicle 20.

The server 10 includes a server controller 12 and a server communication interface 14. The server controller 12 may include at least one processor. The server controller 12 is also referred to simply as a controller. The “processor” in the present embodiment may be, but is not limited to, a general-purpose processor, or a dedicated processor that is dedicated to specific processing. The server controller 12 may include at least one dedicated circuit. The dedicated circuit may include, for example, a Field-Programmable Gate Array (FPGA) or an Application Specific Integrated Circuit (ASIC). The server controller 12 may include the dedicated circuit instead of the processor, or may include the dedicated circuit along with the processor. The server communication interface 14 includes a communication module and may communicate with the vehicle 20. The server 10 may further include a memory. The memory may be, but is not limited to, a semiconductor memory, a magnetic memory, or an optical memory. The memory may function as, for example, a main memory, an auxiliary memory, or a cache memory. The memory may include an electromagnetic storage medium, such as a magnetic disk. The memory may include a non-transitory computer readable medium. The memory may store any information used for the operations of the server 10. For example, the memory may store a system program, an application program, or the like. The server 10 may store a program, information, or the like, using the DB 15 as the memory.

The vehicle 20 boards the user to operate. The vehicle 20 may be configured to allow the user to be on board. For example, the vehicle 20 may include a seat or the like that allows the user to sit. The vehicle 20 is not limited to one and may be two or more in number.

The vehicle 20 may be configured to operate using automated driving. The automated driving may be, for example, performed at any level from Level 1 to Level 5 as defined by the Society of Automotive Engineers (SAE). The automated driving may be performed based on other definitions without being limited to the exemplified definition.

The vehicle 20 includes a control apparatus 22 and a communication apparatus 24. The control apparatus 22 and the communication apparatus 24 are communicably connected to each other, for example, via an in-vehicle network, such as a Controller Area Network (CAN), or a dedicated line.

The control apparatus 22 controls individual components included in the vehicle 20. The control apparatus 22 may include at least one processor. The control apparatus 22 may include at least one dedicated circuit instead of the processor, or may include at least one dedicated circuit along with the processor. The control apparatus 22 may further include a memory.

The communication apparatus 24 communicates with the server 10 via the network 40. The communication apparatus 24 may communicate with the terminal apparatus 30 via the network 40, or may communicate with the terminal apparatus 30 without using the network 40. The communication apparatus 24 may be, for example, an in-vehicle communication device. The communication apparatus 24 may include a communication module for connection with the network 40. The communication module may include, but is not limited to, a communication module conforming to mobile communication standards, such as the 4th Generation (4G) standard and the 5th Generation (5G) standard.

The vehicle 20 further includes a position information acquisition apparatus 25, although this is not required. The position information acquisition apparatus 25 and other components mounted in the vehicle 20 are connected so as to communicate with each other, via the in-vehicle network such as the CAN, or the dedicated line. The position information acquisition apparatus 25 acquires position information for the vehicle 20. The position information acquisition apparatus 25 may include a receiver conforming to a satellite positioning system. The receiver conforming to the satellite positioning system may include, for example, a Global Positioning System (GPS) receiver. In the present embodiment, the vehicle 20 is assumed to be capable of acquiring the position information for the vehicle 20 itself by using the position information acquisition apparatus 25. The vehicle 20 may output the position information for the vehicle 20 itself to the server 10 or the terminal apparatus 30.

The terminal apparatus 30 may communicate with the vehicle 20 via the network 40 or without using the network 40. The terminal apparatus 30 communicates with the server 10 via the network 40. The terminal apparatus 30 may include, for example, a mobile terminal such as a smartphone.

The terminal apparatus 30 may run an application that is used by the user to apply for boarding. The terminal apparatus 30 may communicate with the server 10 to transmit and receive information regarding the application for boarding. When the user boards the vehicle 20, the terminal apparatus 30 may communicate with the vehicle 20 and transmit and receive information for authenticating whether the vehicle 20 is the vehicle 20 allocated to the application from the user.

The terminal apparatus 30 may include a configuration that, for example, is identical or similar to that of the position information acquisition apparatus 25 included in the vehicle 20 to thereby acquire the position information for the terminal apparatus 30 itself. The terminal apparatus 30 may output the position information for the terminal apparatus 30 itself to the server 10 or the vehicle 20.

(Operation Example of Operation Management System 1)

<Application for Boarding>

The terminal apparatus 30 accepts an input from the user to apply for boarding. The terminal apparatus 30 generates boarding application information based on the input from the user, and transmits the boarding application information to the server 10. The boarding application information includes a point or an area at which the user wants to board the vehicle 20 and a point or an area at which the user wants to alight from the vehicle 20. The point or the area at which the user wants to board the vehicle 20 is also referred to as a desired point of origin. The point or the area at which the user wants to alight from the vehicle 20 is also referred to as a desired destination. The boarding application information may further include a time or a time of day at which the user wants to board the vehicle 20, or a time or a time of day at which the user wants to alight from the vehicle 20. The time or the time of day at which the user wants to board the vehicle 20 is also referred to as a desired departure time. The time or the time of day at which the user wants to alight from the vehicle 20 is also referred to as a desired arrival time. A condition that the user desires the vehicle 20 for boarding to preferably meet is also referred to as a desired condition.

<Determination of Vehicle 20>

The server controller 12 of the server 10 manages the operation of the vehicle 20 based on the boarding application information received from the terminal apparatus 30 of at least one user. The server controller 12 manages the operation of at least one vehicle 20. The server controller 12 determines the operation route or the operation schedule for the vehicle 20 based on the desired condition of the at least one user.

The server controller 12 extracts the vehicle 20 that satisfies the desired condition of the user included in the boarding application information. If none of the at least one vehicle 20 satisfies the desired condition of the user, the server controller 12 may extract the vehicle 20 that, in part, does not satisfy the desired condition of the user. In the case in which none of the at least one vehicle 20 satisfies the desired condition of the user, the server controller 12 may transmit, to the terminal apparatus 30, information proposing the user to change the desired condition. The terminal apparatus 30 accepts an input as to whether the user accepts the change in the desired condition. When the user accepts the change in the desired condition, the terminal apparatus 30 also accepts an input as to the condition to be changed. The terminal apparatus 30 transmits, to the server 10, the information inputted by the user. When the user has changed the desired condition, the server controller 12 extracts the vehicle 20 that satisfies the desired condition after the change.

The server controller 12 transmits, to the terminal apparatus 30, information regarding the extracted vehicle 20. The terminal apparatus 30 notifies the user of the information on the extracted vehicle 20, accepts an input as to whether the user agrees or refuses to board that vehicle 20, and transmits a result of the input to the server 10. When the user agrees to board the extracted vehicle 20, the server controller 12 determines to board the user on that vehicle 20. The vehicle 20 on which it is determined to board the user is also referred to as a boarding vehicle. When the user refuses to board the extracted vehicle 20, the server controller 12 extracts a different vehicle 20 and transmits information thereon to the terminal apparatus 30. The server controller 12 may determine the extracted vehicle 20 to be the boarding vehicle as it is.

The server controller 12 determines the operation schedule so as to board the user on the determined boarding vehicle. The server controller 12 transmits, to the boarding vehicle, a control instruction including the operation schedule. The server controller 12 transmits, to the terminal apparatus 30 of the user, information regarding the boarding point and the boarding time as determined based on the operation schedule.

<Handling of Events Occurring in Vehicle 20>

An event may occur in the vehicle 20 with the user on board. Based on the occurred event, the server controller 12 grants an incentive to the user who is on board the vehicle 20 in which the event has occurred. The server controller 12 grants the incentive to the user by transmitting information regarding the incentive to the terminal apparatus 30 of the user.

As the incentive, for example, the server controller 12 may grant a right to have an application accepted more preferentially for boarding than those by other users the next time the user applies for boarding. The server controller 12 may grant a right to have a desired condition designated the next time the user applies for boarding prioritized over those of other users.

The incentive may be granted, for example, by returning the user a fare of the vehicle 20. The incentive may be granted, for example, as points that can be used for payment of the fare of the vehicle 20. That is, the incentive may be granted as a right regarding the fare of the vehicle 20. The incentive may be granted as electronic money. The incentive may be granted as points that can be exchanged for valuables or a paid service.

The event may include, for example, that a change is made to the operation route for the vehicle 20 while the user is on board. The server controller 12 can change the operation route for the vehicle 20 when congestion, closed traffic, or the like due to an accident, a construction, heavy traffic, or the like occurs on the operation route for the vehicle 20.

The event may include, for example, that a delay occurs in the operation of the vehicle 20 while the user is on board. The vehicle 20 may possibly arrive at the destination with a delay from the time specified in the operation schedule when congestion due to an accident, a construction, heavy traffic, or the like occurs on the operation route. The control apparatus 22 of the vehicle 20 may transmit, through the communication apparatus 24 to the server 10, information regarding the delay in the operation of the vehicle 20 as information regarding the event.

The occurrence of the event regarding the operation of the vehicle 20 may cause a delay in the time at which the user arrives at the destination. Further, the change in the operation route for the vehicle 20 may lead to a situation in which, due to a failure of the vehicle 20 to pass the destination of the user, the user is unable to alight at the destination. That is, the event regarding the operation of the vehicle 20 may cause a disadvantage to the user.

When the user suffers the disadvantage from the event regarding the operation of the vehicle 20, the server controller 12 grants the incentive to that user. The server controller 12 may determine the incentive to be granted based on the delay in the arrival time. The server controller 12 may grant the incentive of a greater advantage to the user as the delay in the arrival time is longer.

The event may include, for example, that the number of passengers is greater than a predetermined number, or that a vehicle occupancy is greater than a predetermined value. The predetermined number as the condition of the number of passengers may be set, for example, to a value equal to a capacity of the vehicle 20 or may be set to another value. The vehicle occupancy is calculated as a ratio of the number of passengers to the capacity of the vehicle 20. The predetermined value as the condition of the vehicle occupancy may be set, for example, to 100% or may be set to another value. The server 10 can calculate the number of passengers or the vehicle occupancy by accepting the application for boarding from the user. The server 10 may receive, from the vehicle 20, information regarding the number of passengers or the vehicle occupancy.

The event may include, for example, that a state of the vehicle 20 satisfies a predetermined condition. The predetermined condition includes a condition that deteriorates a boarding environment for the user. The predetermined condition may include, for example, that a temperature, a humidity, or the like inside the vehicle 20 departs from a predetermined range. The predetermined condition may include, for example, that the intensity of odor in the air inside the vehicle 20 exceeds a predetermined value. The predetermined condition may include, for example, that an absolute value of an acceleration of the vehicle 20 exceeds a predetermined value due to a sudden acceleration or deceleration of the vehicle 20. The control apparatus 22 of the vehicle 20 may acquire a measured value from a sensor that detects the state of the vehicle 20 and transmit the measured value through the communication apparatus 24 to the server 10. The sensor may include, for example, a temperature sensor, a humidity sensor, an odor sensor, an acceleration sensor, etc. The server 10 may judge whether the state of the vehicle 20 satisfies the predetermined condition based on the measured value acquired from the control apparatus 22. The control apparatus 22 may judge whether the state of the vehicle 20 satisfies the predetermined condition based on the measured value and transmit a result of the judgement to the server 10. That is, the control apparatus 22 may transmit, through the communication apparatus 24 to the server 10, information regarding the state of the vehicle 20 as the information regarding the event.

An increase in the number of passengers or the vehicle occupancy of the vehicle 20 may deteriorate the boarding environment for the user. Further, it may deteriorate the boarding environment for the user that the state of the vehicle 20 satisfies the predetermined condition. The deterioration in the boarding environment may cause a disadvantage to the user. When the boarding environment for the user is deteriorated, the server controller 12 grants the incentive to the user who is on board the vehicle 20. The server controller 12 may determine the incentive to be granted, based on how large is the number of passengers exceeding the predetermined number or on how high the vehicle occupancy is. The server controller 12 may grant the incentive of a greater advantage to the user as the number of passengers exceeding the predetermined number is greater, or as the vehicle occupancy is higher.

The server controller 12 may transmit, to the terminal apparatuses 30 of some of the at least one user, information requesting for alighting so as to maintain the boarding environment for the user. The user may accept the request for alighting and alight from the vehicle 20. The server controller 12 may regard the user's acceptance of the request for alighting as the occurrence of the event. The server controller 12 grants the incentive based on the occurrence of the event to the user who has accepted the request for alighting. The server controller 12 may determine the incentive based on the position at which the user alights. The server controller 12 may grant the incentive of a greater advantage to the user as the position at which the user alights is farther away from the destination of the user.

<Summary>

As has been described, the operation management system 1 according to the present embodiment grants the incentive to the user who is on board the vehicle 20 when the event has occurred in the vehicle 20. In this way, even when the user suffers a disadvantage due to the occurrence of the event, the disadvantage may be compensated for. In other words, it can be said that the difference in the boarding environment is substantially reflected in the fare. Thus, a sense of fairness can be provided to the user who boards the vehicle 20.

(Example of Flowchart Illustrating Operation Management Method)

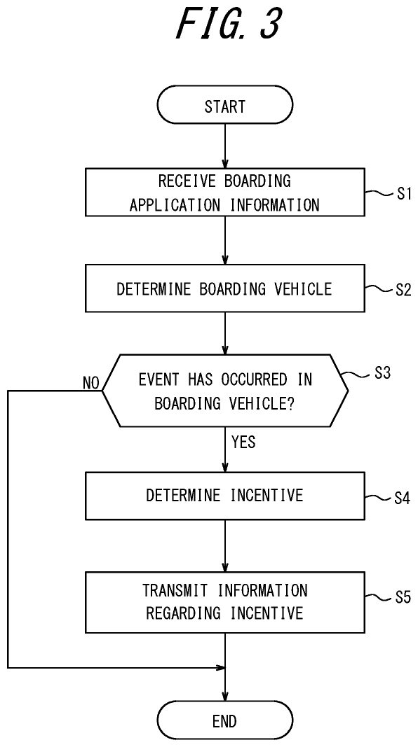

The server controller 12 of the server 10 included in the operation management system 1 may execute an operation management method including a procedure of the flowchart illustrated in FIG. 3. The operation management method may be implemented as an operation management program to be executed by a processor such as the server controller 12. The operation management program may be stored on a non-transitory computer readable medium.

The server controller 12 receives the boarding application information from the terminal apparatus 30 of the user (Step S1). Based on the boarding application information, the server controller 12 determines the boarding vehicle that the user is to board (Step S2).

The server controller 12 judges whether the event has occurred in the boarding vehicle that the user is on board (Step S3). When no event has occurred in the boarding vehicle (Step S3: NO), the server controller 12 ends the execution of the procedure in the flowchart of FIG. 3.

When the event has occurred in the boarding vehicle (Step S3: YES), the server controller 12 determines the incentive to be granted to the user (Step S4). The server controller 12 transmits, to the terminal apparatus 30 of the user, the information regarding the incentive to be granted to the user (Step S5). After executing the procedure in Step S5, the server controller 12 ends the execution of the procedure in the flowchart of FIG. 3.

As described above, according to the operation management method or the operation management program according to the present embodiment, when the event has occurred in the vehicle 20, the incentive is granted to the user who is on board the vehicle 20. In this way, even when the user suffers a disadvantage due to the occurrence of the event, the disadvantage may be compensated for. In other words, it can be said that the difference in the boarding environment is substantially reflected in the fare. Thus, a sense of fairness can be provided to the user who boards the vehicle 20.

While an embodiment of the present disclosure has been described with reference to the drawings and examples, it should be noted that various modifications and revisions may be implemented by those skilled in the art based on the present disclosure. Accordingly, such modifications and revisions are included within the scope of the present disclosure. For example, functions or the like included in each means, each step, or the like can be rearranged without logical inconsistency, and a plurality of means, steps, or the like can be combined together or divided.

1. An operation management apparatus, comprising
a controller configured to manage operation of a vehicle for boarding a user, wherein
the controller is configured to grant an incentive to the user based on an event that has occurred in the vehicle while the user is on board.

2. The operation management apparatus according to claim 1, wherein
the event includes that a change is made to an operation route for the vehicle while the user is on board.

3. The operation management apparatus according to claim 1, wherein
the event includes that a delay occurs in the operation of the vehicle while the user is on board.

4. The operation management apparatus according to claim 1, wherein
the event includes that a state of the vehicle satisfies a predetermined condition.

5. The operation management apparatus according to claim 1, wherein
the event includes that the number of passengers in the vehicle is greater than or equal to a predetermined number, or that a vehicle occupancy of the vehicle is greater than or equal to a predetermined value.

6. The operation management apparatus according to claim 1, wherein
the event includes that, when the controller requests the user to alight from the vehicle, the user accepts a request for alighting.

7. The operation management apparatus according to claim 1, wherein
the incentive includes a right to have an application by the user preferentially accepted for boarding the vehicle.

8. The operation management apparatus according to claim 1, wherein
the incentive includes a right regarding a fare of the vehicle.

9. An operation management system comprising:
the operation management apparatus according to claim 1; and
the vehicle.

10. An operation management method executed by an operation management apparatus configured to manage operation of a vehicle for boarding a user, the operation management method comprising
granting an incentive to the user based on an event that has occurred in the vehicle while the user is on board.

11. The operation management method according to claim 10, wherein
the event includes that a change is made to an operation route for the vehicle while the user is on board.

12. The operation management method according to claim 10, wherein
the event includes that a delay occurs in the operation of the vehicle while the user is on board.

13. The operation management method according to claim 10, wherein
the event includes that a state of the vehicle satisfies a predetermined condition.

14. The operation management method according to claim 10, wherein
the event includes that the number of passengers in the vehicle is greater than or equal to a predetermined number, or that a vehicle occupancy of the vehicle is greater than or equal to a predetermined value.

15. The operation management method according to claim 10, wherein
the event includes that the user accepts a request for alighting from the vehicle.

16. The operation management method according to claim 10, wherein
the incentive includes a right to have an application by the user preferentially accepted for boarding the vehicle.

17. The operation management method according to claim 10, wherein
the incentive includes a right regarding a fare of the vehicle.

18. A vehicle for boarding a user to operate, wherein the vehicle is configured to
transmit, to an operation management apparatus, information regarding an event that has occurred while operating with the user on board, so as to enable the operation management apparatus to grant the user an incentive based on the event.

19. The vehicle according to claim 18, wherein
the information regarding the event includes information regarding a delay in operation of the vehicle.

20. The vehicle according to claim 18, wherein
the information regarding the event includes information regarding a state of the vehicle.
